(19) United States
(12) Patent Application Publication
(10) Pub. No.: US 2009/0179571 A1
(43) Pub. Date: Jul. 16, 2009

(54) Method for Detecting Faults During Operation of High-Pressure Discharge Lamp Using Electronic Ballasts

(75) Inventors: Stefan Boldt, Berlin (DE); Joachim Mühlschlegel, Gröbenzell (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, MUNICH (DE)

(21) Appl. No.: 12/085,993

(22) PCT Filed: Nov. 28, 2006
(86) PCT No.: PCT/EP2006/069006

§ 371 Date: Dec. 31, 2008

(30) Foreign Application Priority Data
Dec. 6, 2005 (DE) 10 2005 058 222.2

(51) Int. Cl. H05B 41/36

(52) U.S. Cl. 315/119; 315/119

(57) ABSTRACT

According to the invention, a state automaton is used when operating a high-pressure discharge lamp on a ballast operated by means of a microprocessor in order to prevent certain malfunctions.

### TECHNICAL FIELD

The invention is based on a method for detecting faults during operation of high-pressure discharge lamps using electronic ballasts, in particular using electronic ballasts having an integrated microprocessor, in accordance with the precharacterizing clause of claim 1. These lamps are, in particular, metal halide lamps, in particular for general lighting, or else sodium high-pressure lamps.

### PRIOR ART

EP-A 1 476 003 has disclosed a method for operating a high-pressure discharge lamp, in which a detection device attempts to prevent erroneous functioning.

### SUMMARY OF THE INVENTION

The object of the present invention is to provide a method for operating a high-pressure discharge lamp in accordance with the precharacterizing clause of claim 1, which ensures improved fault detection and, in particular, avoids the disadvantages of the prior art.

This object is achieved by the characterizing features of claim 1. Particularly advantageous refinements are given in the dependent claims.

The operation of metal halide lamps is split roughly into various states, which have a specific sequence over time. If this sequence is not adhered to, the lamp is defective and it is not possible for the electronic ballast to change over to the following logically correct state. This is referred to as a forbidden state, and in this state the electronic ballast disconnects the lamp up to the next system reset. As a result, defective lamps and lamps at the end of their life are no longer operated. As a result, hazards, such as damage to luminaires and lampholders owing to outer bulb discharges and the “incandescent mode” cannot occur (risk of fire). The difference between this strategy and the strategies used in the electronic ballast on the market is the fact that not only voltage limits or temporal limits lead to a shutdown, but a state machine is used which only permits a very specific sequence. The change in states of the machine is likewise controlled by voltage and time parameters, but the sequence of the states is critical. Previous electronic ballasts cannot detect the so-called “incandescent mode” since this mode has an electrical response which is similar to a discharge of a lamp which has been run up. Using this strategy, it is initially completely impossible for the “incandescent mode” to arise, since outer bulb discharges lead to immediate shutdown. Furthermore, this provides the security of good lamps not being shut down inadvertently. A precondition for this is that the electronic ballast has a microprocessor. The state machine can be implemented in this microprocessor. This does not influence the circuit technology (step-up converter, step-down converter, half-bridge, full-bridge, etc.).

The first state is the starting phase, which comprises starting. The electronic ballast is in this state once the system voltage has been connected. In this state, an attempt is made to start the lamp by outputting starting voltage. In this case, it is of no consequence whether the device has pulse or resonance starting. The starting state can only be brought about by one of the following conditions:
system voltage off;
starting timer expired (for example after 18 minutes);
transition to the runup state only takes place if an operating voltage is reached which is in a target window of, for example, between 10 and 35 V.

The second state is the runup state, i.e. setting of a startup current. The electronic ballast only reaches the runup state once the first state has been passed through, i.e. only from the starting state. In this state, a runup timer is started and the time-dependent limits of the voltage compared with the lamp voltage. If the time-dependent limits are violated, this is a transition to a forbidden state, which leads to the electronic ballast being shut down. The runup state can only be left as a result of the following conditions:
system voltage off;
possible consideration of internal electronic ballast parameters such as the temperature reached in the electronic ballast, for example;
transition to the next state, normal operation, takes place after a time window which is between two time values t1 and t2, in particular at the earliest after 15 s and at the latest after 160 s, and in addition if the operating voltage exceeds a threshold value, in particular if it is above 70 V. If the operating voltage rises above the threshold value, i.e. in this case to above 70 V, even before the beginning of the time window, for example as early as after 5 s, the machine changes over to the forbidden state. This premature fault can be attributed to the incandescent mode.

The third state is normal operation. The electronic ballast only reaches the normal operation state once the runup state has been passed through. During normal operation, the operating voltage of the lamp is checked continuously. If a maximum permissible upper value is exceeded, in particular a timer is started which shuts down the lamp after a time window, for example after 18 min. If a minimum permissible value is undershot, the lamp is immediately shut down. This prevents operation of an outer bulb discharge.

The normal operation state can only be left if at least one of the following conditions is met:
system voltage off;
possible consideration of internal electronic ballast parameters such as the temperature reached in the electronic ballast, for example;
violation of the voltage limits: an instance of the maximum permissible upper value, for example a voltage limit of 120 V, being exceeded leads to a timer shutdown, for example shutdown after 18 minutes. An instance of the minimum permissible value, for example a voltage limit of 70 V, being undershot leads to the immediate transition to the forbidden state and therefore to shutdown.

Correspondingly, the electronic ballast recognizes a fourth state, the so-called forbidden state. The electronic ballast arrives at the forbidden state if the conditions for a state change as described above are not met. This is either a violation of a voltage limit or a combination of time and voltage limits. In the forbidden state, the electronic ballast is shut down. Only once the system has been cleared and connected can another state be reached.

The states can only be passed through in the sequence 1-3. This is the case for a normal, non-defective lamp. A change from 1 to 3 (equal to the occurrence of the incandescent mode) or from 3 to 2 (equal to an outer bulb discharge) is not allowed and inevitably leads to the forbidden state.

In detail, the novel method for operating high-pressure discharge lamps uses the following steps, split into states:
starting the lamp in the starting phase;
setting a startup current in the runup state which is selected to be so low that electrodes of a connected lamp are not damaged;
normal operation, in which the rated power provided for this purpose is intended to lead to a bandwidth for the rated voltage which is permissible for this purpose.

In this case, a detection device determines whether the set startup current has set the lamp into a state in which the lamp has reached the band of the permissible rated voltage, a state machine monitoring the operation to the extent that a runup state needs to be passed through within a predetermined time window.

A state machine is a machine having a memory, which can react differently to identical input variables depending on the inner state of the memory. One example of this is a flip-flop.

The state machine preferably recognizes at least three different states, the starting state the runup state and the normal operation state. The runup state can particularly preferably be split into a plurality of substates. It is advantageous if these substates clearly follow one another in time.

In the case of discharge lamps for general lighting, there is a lamp defect which is referred to as the “incandescent mode”.

This takes place if the discharge vessel is not tight and filler and filling gas passes into the outer bulb. When such a lamp is started, an outer bulb discharge may now occur, primarily if a pool of filler constituents forms in an outer bulb which is sealed at one end. Owing to this discharge, material of the power supply line is vaporized in the outer bulb, and this material is deposited on the inner wall of the outer bulb. Conductive layers form there. If the conductive layers are arranged such that they are connected to the power supply lines, the “incandescent mode” results. The “incandescent mode” is a situation in which this layer incandesces owing to the current flow. It is generally not possible using the electrical parameters to distinguish this mode from a lamp in the normal state in which it has been run up, since it has neither asymmetry nor operating voltages which differ from normal operation.

Until now it has not been possible to suppress this state, since known methods for operating such lamps only measure instantaneous voltage and current values and respond to these values using limit values and characteristic gradients. However, using a state machine it is possible even to suppress this undesired state.

In this case, the state machine needs to use the same methods as are described in the prior art to determine its state. Owing to the determination of a very specific sequence for passing through these states, the incandescent mode or its production can be suppressed. The occurrence of an identical input variable, for example operating voltage as in normal operation, but an instantaneous inner state of the machine which does not permit a subsequent state “lamp which has been run up”, therefore leads to shutdown.

Since this “incandescent mode” state could until now not be identified, it was, inter alia, for this reason recommended to luminaire manufacturers not to use any plastic lampholders for discharge lamps, since they can melt or even burn in the “incandescent mode”. This restriction no longer applies now, as a result of which it is possible to use cheaper lampholders.

A possible field of application is primarily metal halide lamps, but also sodium high-pressure lamps which have a discharge vessel in an outer bulb.

The state machine can distinguish the three states from one another. In particular, it ensures that the transition from state 1 to state 3 is ruled out. In particular, it also ensures that the transition from state 3 to state 2 is ruled out.

The invention also comprises an operating device for operating a high-pressure discharge lamp, the operating device in particular being an electronic ballast which is operated using a microprocessor, having the following features:
a setting device which sets a startup current;
a detection device;
possibly in particular a regulating device;
possibly a control device;
   the operating device also comprising a state machine, which is preferably part of the detection device, or interacts with it. The state machine can preferably be integrated in a microcontroller. In this case, the program of the microcontroller can also cover the state machine. In particular, it can be accommodated in the control device, for example in the form of an ASIC or a control IC.

The regulating device is suitable for regulating the power of the connected lamp to a desired power. The setting device is suitable for the purpose of limiting a lamp current of the lamp to a limit value. The detection device is designed such that it passes a signal on to a control device if a limit value setting is too low to set a connected lamp into a state in which the lamp assumes the desired power. The control device inputs the limit value to the setting device and possibly increases the limit value if the detection device transmits a signal to the control device. Details are given, for example, in EP-A 1 476 003.

With this operation of a high-pressure discharge lamp using an electronic ballast operated using a microprocessor, a state machine is therefore used for ruling out specific erroneous functions.

A fault-free lamp (without an incandescent mode or other faults) is characterized by the fact that the operating voltage during runup of the lamp has a response which is constant and even increases monotonously in specific ranges. During runup, the lamp current is predetermined by the electronic ballast and is referred to as the startup current. The lamp current is normally predetermined approximately continuously. In this case, the operating voltage of the lamp changes so slowly that the time profile of the operating voltage can be measured by a microcontroller without any technical difficulties. Short changes over time in the operating voltage which occur in the time range of less than 0.2 ms to less than 20 ms are suppressed during measurement by means of averaging over time or by means of low-pass filtering. The averaging or low-pass filtering can in this case be carried out in analog and/or digital fashion.

The necessary conditions for detecting a fault-free lamp which are used are one or more of the following three criteria:

1) Constancy of the operating voltage during runup. This means that no jumps may take place in the time profile which are greater than a specific amount. Short-term jumps are regarded as irrelevant and are therefore filtered out.
2) As an alternative or in addition, the first steep rise in the lamp voltage is used which sets in in the range from 10 s to 30 s after starting the lamp. It is essentially based on the evaporation of Hg. The electronic ballast, in particular an evaluation unit in a microcontroller, needs to find a time section having a suitable length, in which the lamp voltage is strictly monotonous and the gradient of the lamp voltage over time is in a specific value range.

One specific exemplary embodiment for a value range for a 35 W lamp is a time window which is 4 s long. In this time window, the gradient of the lamp voltage should be in the range from 1.5 V/s to 6 V/s for the entire duration of the time window.

3) Positive gradient of the lamp voltage during startup, i.e. in a specific time range after starting of the lamp. In this case, a suitable averaging preferably takes place over the ranges in which the gradient of the lamp voltage is negative or zero for a short period of time. In the simplest case, these ranges are filtered out. One specific example is a specification for the filtering-out if the negative range is less than 10% of the total temporal length of the time window.

### FIGURES

The invention will be explained in more detail below with reference to a plurality of exemplary embodiments. In the drawings:

FIG. 1 shows the operating voltage response during startup of a group of electronic ballast and lamp systems;

FIG. 2 shows the startup response of a lamp over time;

FIG. 3 shows the flowchart with all states;

FIG. 4 shows a schematic of an electronic ballast with a state machine; and

FIG. 5 shows the startup response with a plurality of states.

### DESCRIPTION OF A PREFERRED EMBODIMENT

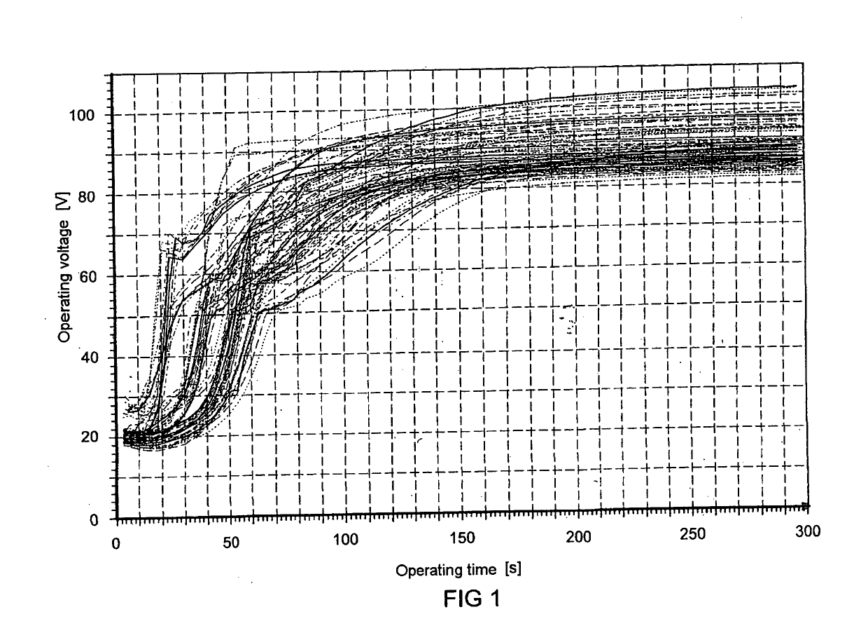

FIG. 1 shows the operating voltage (in volts) during startup using the electronic ballast of in total 77 metal halide lamps. 35-150 W lamp types with a discharge vessel made from quartz glass and with a cylindrical and bulged ceramic discharge vessel are shown. All of the operating positions have also been varied. Since these measurements cover the entire spectrum of metal halide lamps for general lighting, it is possible to conclude from these curves the voltage and time limits which necessarily lead to a shutdown. A fault-free lamp, i.e. without an incandescent mode or other faults, is characterized by the fact that the operating voltage during runup of the lamp has a continuous response which increases even monotonously in specific ranges.

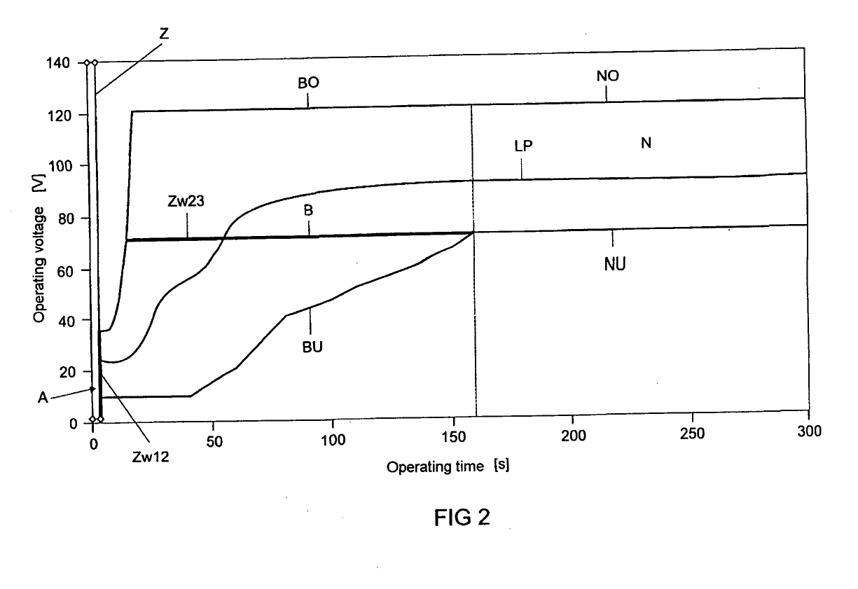

FIG. 2 illustrates, by way of example, the startup of the operating voltage of an individual metal halide lamp as a function of time. Curve A defines the “starting” state, which is limited to a maximum of 18 minutes. Curve B defines the time window of the second state, “runup”; it is a minimum of 15 s and a maximum of 160 s. In this case, the time-dependent upper and lower voltage limits BO and BU, respectively, are also illustrated for the “runup” state. Then, the third state, normal operation N, follows. In this case, the upper and lower limits NO and NU are not time-dependent. Starting itself and its time limit is not illustrated, the time window is merely symbolized by the rhombuses and the voltage range in which starting takes place is symbolized by the line Z. The actual operating response of the lamp is denoted by LP. This figure illustrates the two allowed state changes from state 1->2 (line ZW 12) and from state 2->3 (line ZW 23) using the example of a metal halide lamp. Other changes are not permitted.

All values for the lower limit BU for the time-dependent runup of the lamp are stored in the memory of a microprocessor in the form of a table. The upper limits BO and NO and the lower limit during normal operation NU are individual values which are not time-dependent.

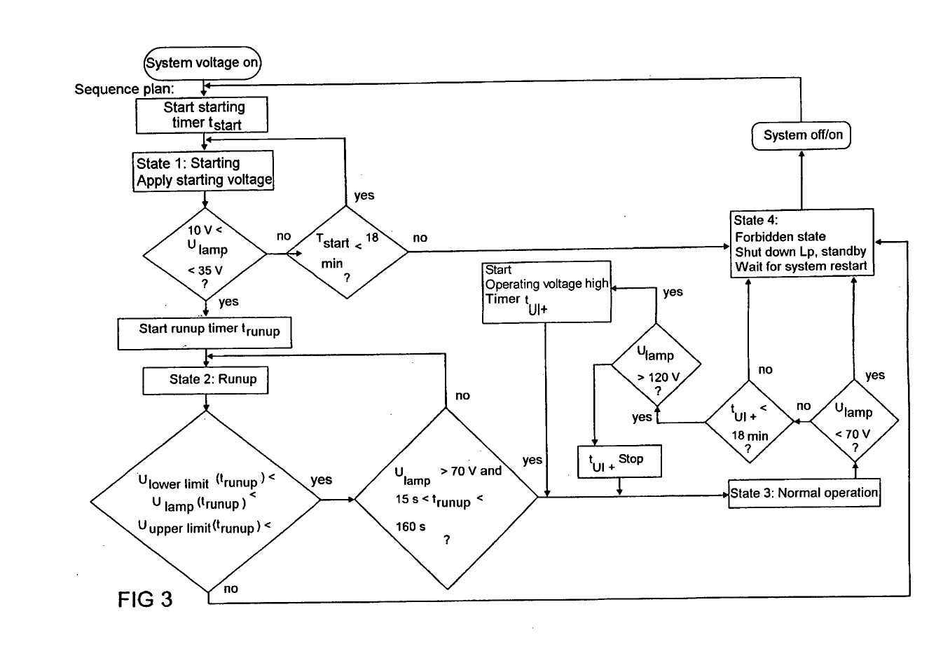

FIG. 3 shows the flowchart with all states. Once the system voltage has been connected, a time window for the starting timer starts. The lamp changes over to state 1. If all criteria are met, the lamp changes over to state 2 once a time window for the runup timer has been started. If all other criteria are met, the lamp changes over to the state 3, normal operation. The response in the event of a fault leads to state 4, the forbidden state, which leads to shutdown of the lamp.

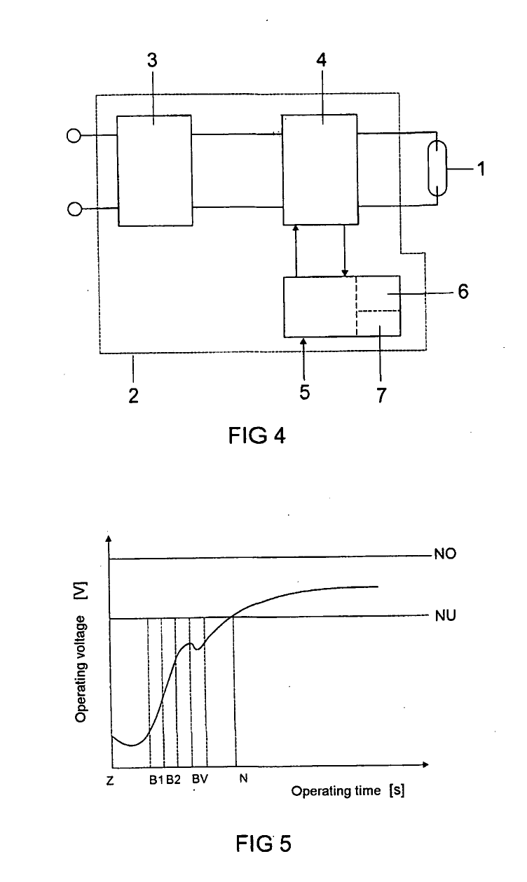

FIG. 4 shows a schematic of a circuit of a metal halide lamp 1. The electronic ballast 2 comprises, as is known per se, a rectifier 3 and an actuating element 4. This actuating element is, for example, in the form of a step-down converter. The actuating element 4 is connected to a detection device 5. A substantial component thereof is the microcontroller 6, or else an IC, having a state machine 7.

FIG. 5 shows a schematic having a plurality of states. After the starting phase in the case of Z, two time windows are monitored as states B1 and B2 in the region of the steep rise during Hg vaporization. In addition, the positive gradient during startup between the starting point B1 and the beginning of normal operation N is monitored. In this case, the region BV of the peak point, which is the transition between the Hg vaporization phase and the vaporization of the metal halides, is suppressed.

1. A method for operating high-pressure discharge lamps having the following steps:
starting the lamp;
setting a startup current, which is selected to be so low that electrodes of a connected lamp are not damaged;
normal operation, in which the rated power provided for this purpose is intended to lead to a bandwidth for the rated voltage which is permissible for this purpose;
characterized in that a detection device determines whether the set startup current has set the lamp into a state in which the lamp has reached the band of the permissible rated voltage, a state machine monitoring the operation to the extent that a runup state needs to be passed through within a predetermined time window.

2. The method as claimed in claim 1, characterized in that the state machine can distinguish at least three states from one another, a first state being the starting phase, a second state being the runup phase and a third state being normal operation.

3. The method as claimed in claim 2, characterized in that the state machine forbids the direct transition from state 1 to state 3.

4. The method as claimed in claim 2, characterized in that the state machine forbids the transition from state 3 to state 2.

5. The method as claimed in claim 2, characterized in that the runup state is split into a plurality of substates.

6. The method as claimed in claim 2, characterized in that these substates follow one another in time.

7. An operating device for operating a high-pressure discharge lamp having the following features:
a setting device;
a detection device;
characterized in that the operating device also comprises a state machine, which is preferably part of the detection device.

8. The operating device as claimed in claim 7, characterized in that the operating device furthermore comprises a regulating device.
